(19) United States
(12) Patent Application Publication
(10) Pub. No.: US 2024/0406427 A1
(43) Pub. Date: Dec. 5, 2024

(54) METHOD AND APPARATUS FOR POINT CLOUD COMPRESSION USING HYBRID DEEP ENTROPY CODING

(71) Applicant: INTERDIGITAL VC HOLDINGS, INC., Wilmington, DE (US)

(72) Inventors: Muhammad Asad Lodhi, Highland Park, NJ (US); Jiahao Pang, Plainsboro, NJ (US); Dong Tian, Boxborough, MA (US)

(73) Assignee: INTERDIGITAL VC HOLDINGS, INC., Wilmington, DE (US)

(21) Appl. No.: 18/698,741

(22) PCT Filed: Oct. 5, 2022
(86) PCT No.: PCT/US2022/045790

§ 371 Date: Apr. 4, 2024

Related U.S. Application Data
(60) Provisional application No. 63/252,482, filed on Oct. 5, 2021.

(51) Int. Cl. H04N 19/44; H04N 19/169; H04N 19/96

(52) U.S. Cl. CPC H04N 19/44; H04N 19/1883; H04N 19/96

(57) ABSTRACT

Methods and apparatuses for decoding and encoding point cloud data are described herein. A method may include accessing point cloud data compressed based on a tree structure. The method may further comprise fetching points in a neighborhood associated with a current node of the tree structure, and computing a feature using a point-based neural network module, based on three-dimensional (3D) locations of the fetched points. The method may include predicting, using a neural network module, an occupancy symbol distribution for the current node based on the feature, and determining the occupancy for the current node from the encoded bitstream and the predicted occupancy symbol distribution. The method may include computing another feature using a convolution-based neural network module, based on a voxelized version of the fetched points, and fusing the feature and the another feature with one or more known features of a current node to compose a comprehensive feature.

### CROSS-REFERENCE TO RELATED APPLICATIONS

This application claims the benefit of U.S. Provisional Application No. 63/252,482, filed Oct. 5, 2021, the contents of which are incorporated herein by reference.

### FIELD OF INVENTION

The present disclosure relates to point cloud compression and processing. More specifically, the present disclosure aims to provide tools for compression, analysis, interpolation, representation and understanding of point cloud signals.

### BACKGROUND

Point clouds are a universal data format used across several business domains including autonomous driving, robotics, augmented reality/virtual reality (AR/VR), civil engineering, computer graphics, and the animation/movie industry. Three dimensional (3D) Light Detection and Ranging (LiDAR) sensors have been deployed in self-driving cars, and affordable LiDAR sensors have been implemented in, for example, the Velodyne Velabit, Apple iPad Pro 2020 and Intel RealSense LiDAR camera L515. With advances in sensing technologies, 3D point cloud data has become more useful than ever and is expected to be an ultimate enabler in the applications mentioned.

Point cloud data is also believed to consume a large portion of network traffic, e.g., among connected cars over 5G networks, and in immersive communication (VR/AR). Efficient representation formats are necessary for point cloud understanding and communication. In particular, raw point cloud data need to be properly organized and processed for the purposes of world modeling and sensing. Compression for raw point clouds is essential when storage and transmission of the data are required in the related scenarios.

Furthermore, point clouds may represent a sequential scan of the same scene, which may contain multiple moving objects. Such point clouds are called dynamic point clouds and stand in contrast to static point clouds captured from a static scene or static objects. Dynamic point clouds are typically organized into frames, with different frames being captured at different time. Dynamic point clouds may require the processing and compression to be in real-time or with low delay.

### SUMMARY

Methods and apparatuses for decoding and encoding point cloud data are described herein. A method may include accessing point cloud data compressed based on a tree structure. The method may further comprise fetching points in a neighborhood associated with a current node of the tree structure, and computing a feature using a point-based neural network module, based on three-dimensional (3D) locations of the fetched points. The method may include predicting, using a neural network module, an occupancy symbol distribution for the current node based on the feature, and determining the occupancy for the current node from the encoded bitstream and the predicted occupancy symbol distribution. The method may include computing another feature using a convolution-based neural network module, based on a voxelized version of the fetched points, and fusing the feature and the another feature with one or more known features of a current node to compose a comprehensive feature.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is a block diagram illustrating an example of a system suitable for implementing one or more of the examples of embodiments described herein;

FIG. 2 depicts an example of a deep entropy model for encoding of a bitstream following the OctSqueeze architecture;

FIG. 3A is a graphical representation of the raw input point cloud as may be processed according to a VoxelContextNet deep entropy model;

FIG. 3B is a diagram illustrating a corresponding octree for the raw input point cloud of FIG. 3A;

FIG. 3C is a diagram illustrating the detailed binary voxel representation of the input point cloud of FIG. 3A;

FIG. 4 is a diagram illustrating a point-based architecture according to some embodiments;

FIG. 5 illustrates an example of an enhanced PointContextNet architecture;

FIG. 6 illustrates yet another example of an enhanced PointContextNet architecture;

FIG. 7 illustrates an example of a hybrid deep entropy model consistent with one or more embodiments disclosed herein;

FIG. 8 illustrates an example design of the convolution-based branch of a hybrid deep entropy model;

FIG. 9 is a flow diagram illustrating an example of point cloud encoding using a proposed deep entropy model consistent with one or more of the embodiments presented herein;

FIG. 10 is a flow diagram illustrating an example of point cloud decoding using a proposed deep entropy model consistent with one or more of the embodiments presented herein;

FIG. 11 illustrates various methods for 3D space partitioning and point cloud representation, including Octree, Quadtree, and Binary tree; and

FIG. 12 is an example illustrating quadtree plus binary tree (QTBT) partitioning of a 3D point cloud.

### DETAILED DESCRIPTION

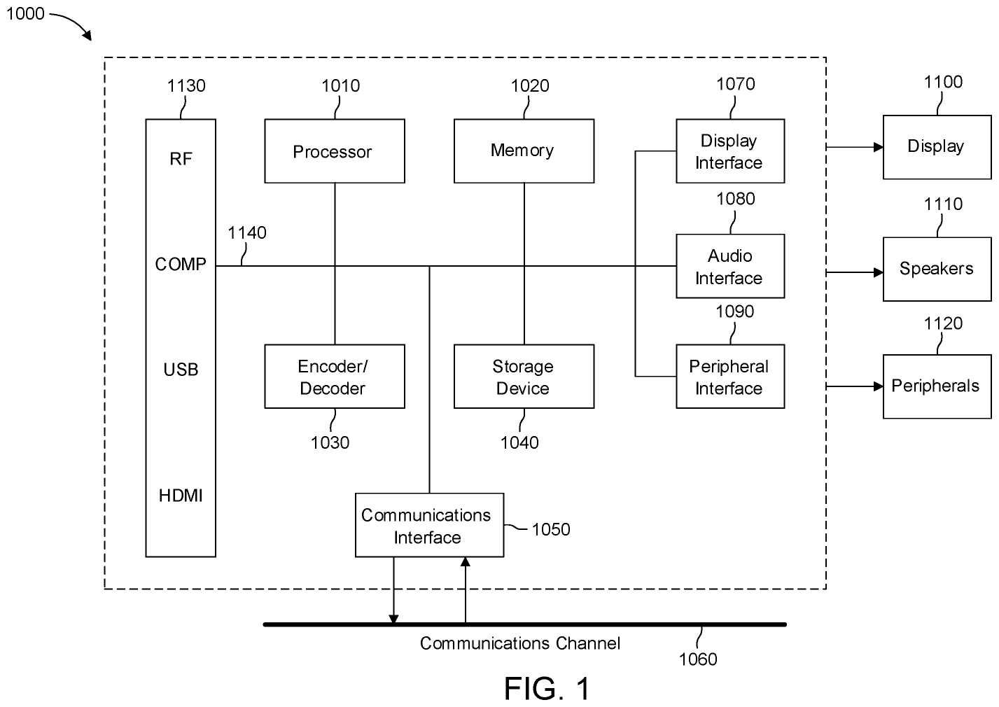

FIG. 1 is a block diagram illustrating an example of a system suitable for implementing one or more of the examples of embodiments described herein. System 1000 in FIG. 1 may be embodied as a device including the various components described below and may be configured to perform or implement one or more of the examples of embodiments, features, etc. described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In general, the system 1000 is configured to implement one or more of the examples of embodiments, features, etc. described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). Memory 1020 may be a non-transitory storage medium that stores instructions to be executed by the at least one processor 1010. System 1000 includes a storage device 10400, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030, e.g., to perform or implement one or more examples of embodiments, features, etc., described in this document, can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 10000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (12C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network (such as a network operating in accordance with Third Generation Partnership Project (3GPP) standards) or a Bluetooth network.

System 1000 may be implemented in a device such as a wireless transmit/receive units (WTRU) designed to operate (i.e., transmit and/or receive signals) via the communications interface 1050 within one or more wireless environments such as a radio access network (RAN), a core network (CN), a public switched telephone network (PSTN), the Internet, and/or other networks. By way of further example, the system may be implemented a station (STA), user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks.

The system 1000 can provide an output signal to various output devices, including a display 110, speakers 1110, and other peripheral devices 1120. The display 110 of various embodiments includes one or more of, for example, a touchscreen display, an organic light-emitting diode (OLED) display, a curved display, and/or a foldable display. The display 110 can be for a television, a tablet, a laptop, a cell phone (mobile phone), or another device. The display 110 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 110, speakers 1110, or other peripheral devices 1120 using signaling such as AVLink, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 110 and speakers 1110 can be integrated in a single unit with the other components of system 1000 in an electronic device such as, for example, a television. In various embodiments, the display interface 1070 includes a display driver, such as, for example, a timing controller (T Con) chip.

The display 110 and speaker 1110 can alternatively be separate from one or more of the other components, for example, if the RF portion of input 1130 is part of a separate set-top box. In various embodiments in which the display 110 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples. By way of further example, the processor 1010 may be a conventional processor, a digital signal processor (DSP), a microprocessor in association with a DSP core, a controller, a microcontroller, Application Specific Integrated Circuits (ASICs), Field Programmable Gate Arrays (FPGAs), any other type of integrated circuit (IC), a state machine, and the like. The processor 1010 may perform signal coding, data processing, power control, input/output processing, and/or any other functionality that enables the WTRU 1020 to operate in a wireless environment. The processor 1010 may be coupled to the encoder/decoder 1030, to the memory 1020, the storage device 1040, the communications interface 1050, the display interface 1070, the audio interface 1070, the peripheral interface 1090, or input block 1130.

Various use cases in which point clouds may be implemented are described herein. For example, the automotive industry and especially autonomous car development are domains in which point clouds may be used. It may be desirable that autonomous cars be able to “probe” their environment to enable informed driving decisions based on the reality of their immediate surroundings. Point clouds may be static or dynamic and are typically of averaged size, say no more than millions of points at a time. For instance, some sensors, such as those used in Light Detection and Ranging (LiDAR) technologies may produce dynamic point clouds that may be used by a perception engine. These point clouds may not be intended for viewing by human eyes and may be sparse, may or may not provide color attributes, and/or be captured with a high frequency of capture. Point clouds may store other attributes such as a reflectance ratio provided by the LiDAR—an attribute which may be indicative of the material of sensed objects and may help in making a decision.

Virtual Reality (VR) and immersive worlds are a hot topic and are viewed by many as the future of two-dimensional (2D) flat video. The basic idea of VR and immersive worlds may be to immerse a viewer in an environment all around them as opposed to standard TV by which the viewer may only look at the virtual world in front of him. Several gradations in immersivity may be afforded to the viewer depending on the freedom of the viewer in the environment. A point cloud may be one candidate format through which VR worlds may be distributed.

Point clouds may be also used for various purposes such as in 3D scanning of an object in order to share the spatial configuration of the object without sending or visiting it (for instance in the case of cultural heritage/buildings). Also, such point clouds may ensure preservation of the spatial configuration of the object in case it may be destroyed; for instance, a temple by an earthquake. Such point clouds are typically static, colored, and store a large amount of data.

Topography and cartography are further examples of use cases for point clouds in which, using 3D representations, maps are not limited to the plane and may include the relief. Google Maps is one example of a tool for displaying and manipulating 3D maps, but it uses meshes instead of point clouds. Nevertheless, point clouds may be a suitable data format for 3D maps and such point clouds are typically static, colored, and store a large amount of data.

World modeling and sensing via point clouds may be a critical technology for enabling machines to gain knowledge about the 3D world around them, which may be crucial for the applications discussed above. Although the present disclosure is provided with the foregoing in mind, person of skill in the art will appreciate that point clouds, as well as techniques for compression of such data may have other applications, for example, beyond the spatial representation of data.

3D point cloud data may be understood as discrete samples on the surfaces of objects or scenes. To fully represent the real world with point samples, in practice, a 3D point cloud may require a huge number of points. For instance, a typical VR immersive scene may contain millions of points, while point clouds may contain hundreds of millions of points. Therefore, the processing of such large-scale point clouds may be computationally expensive, especially for consumer devices, e.g., smartphones, tablets, and automotive navigation systems, which may have limited computational power.

An initial step for improving processing or inference on the point cloud may be to have efficient storage methodologies. To store and process the input point cloud with affordable computational costs, one solution may be to down-sample the input point cloud first such that the down-sampled point cloud summarizes the geometry of the input point cloud while having much fewer points. The down-sampled point cloud may then be fed to the subsequent machine task for further consumption. However, further reduction in storage space can be achieved by converting the raw point cloud data (whether original or downsampled) into a bitstream through entropy coding techniques for lossless compression. Better entropy models may result in a smaller bitstream and hence more efficient compression. Additionally, entropy models may be also paired with downstream tasks which may allow the entropy encoder to maintain the task-specific information while performing compression. In addition to lossless coding, some scenarios may call for lossy coding in order to significantly improve the compression ratio while maintaining the induced distortion under certain quality levels.

Various embodiments for octree-based point cloud compression are described herein. A point cloud may be represented via an octree decomposition tree. A root node may cover a full space in a bounding box. The space may be equally split in every direction, i.e., x-, y-, and z-directions, leading to eight (8) voxels. For each voxel, if there is at least one point, the voxel may be marked by a single bit as occupied, for example by ‘1’; otherwise, it may be marked as empty, represented by ‘0’. The root voxel node may then be described by an 8-bit value. For each occupied voxel, its space may be further split into eight (8) child voxels before moving to the next level of the octree. Based on the occupancy of the child voxels, the current voxel is further represented by an 8-bit value. The splitting of occupied voxels may continue until the last octree depth level. The leaves of the octree finally represent a point cloud. Such splitting division may be carried out, conceivably, any number of times so as to reach a desired level of granularity.

On the encoder side, the octree nodes (node values) may be sent to an entropy coder to generate a bitstream. A decoder may then use the decoded octree node values to reconstruct the octree structure and eventually reconstruct a point cloud based on the leaf nodes of the octree structure.

To efficiently code the octree nodes using entropy techniques, a probability distribution model may be utilized to allocate shorter symbols for octree node values appearing more often. In other words, for symbols with higher probability of occurrence, the probability distribution model may provide increased efficiency by enabling the use of fewer bits in a bitstream to represent more frequently occurring information.

Point clouds may represent both large smooth surfaces or intricate structures. It may be challenging to use a single model to analyze the different types of structures. Hence, accurate predictions of the probability distribution for an entropy coder across an entire point cloud may be especially challenging.

Various techniques for deep entropy coding are described herein. One example described in further detail below entails learning-based octree coding for point clouds. Deep entropy models may refer to a category of learning-based approaches that attempt to formulate a context model using a neural network module to predict the probability distribution.

One existing deep entropy model may be referred to herein as OctSqueeze. This deep entropy model may operate in a nodewise fashion. An octree representation is first constructed from raw point cloud data. In building the octree representation, OctSqueeze may utilize ancestor nodes at various depth levels including a parent node, a grandparent node, etc., in a hierarchical manner. A number of Multi-Layer Perceptron (MLP)-based modules may be used to predict a probability distribution for the occupancy symbol of a given node, depending on the context of the node and one or more ancestor nodes. The context of the current node includes information about one or more of: the location, octant, the level (or depth), and/or the parent node. The operation can be carried out serially or in parallel. The predicted probability distribution may then be further used by either an adaptive entropy encoder or decoder to compress the tree structure, resulting in an encoded bitstream.

While using the deep entropy model during decoding, the ancestor nodes must be decoded before moving down the octree. Thus, decoding can operate in parallel only over sibling nodes. That is, one or more examples of embodiments in this disclosure can operate during encoding in parallel over all nodes and, during decoding, can operate in parallel only over sibling nodes.

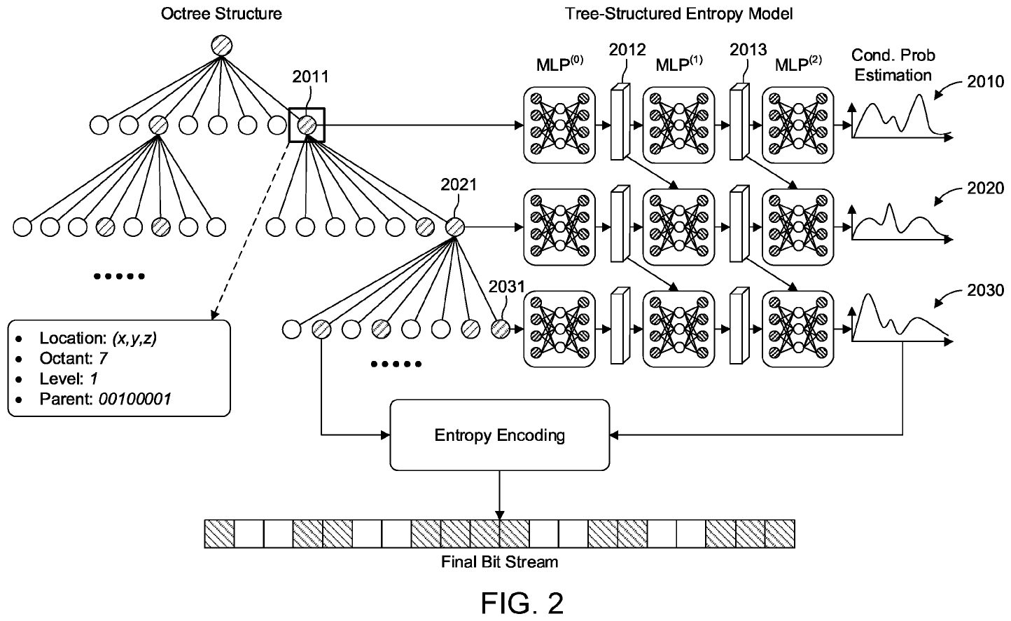

FIG. 2 depicts an example of a deep entropy model for encoding of a bitstream following the OctSqueeze architecture. In the example depicted in FIG. 2, three MLP modules are implemented as shown for each of nodes 2011, 2021, and 2031. For a given node, a first MLP module takes the context of the current node as an input and generates an output feature 2012. A second MLP module takes the outputted feature of two such first MLP modules as inputs, one from the current octree depth level and the other from the parent octree depth level. The second MLP module may then also generate an output feature 2013. A third MLP module takes the outputted features of two of such second MLP modules (i.e., the second MLP module at the depth level of the current node and a second MLP module for the parent node depth level) as an input and generates a condition probability estimation. This process is performed at multiple depth levels of the octree to produce corresponding conditional probability estimates 2010, 2020, and 2030. Entropy encoding is performed to compress the bitstream represented by the octree based on the conditional probability estimates 2010, 2020, and 2030 to produce a final bitstream.

Another existing deep entropy model may be referred to in the present disclosure as VoxelContextNet. Different from OctSqueeze, which may use ancestor nodes, VoxelContextNet may employ an approach using spatial neighbor voxels to first analyze the local surface shape and then predict the probability distribution.

At lower levels of depth within the octree structure, the center of a cube corresponding to a point of cloud approaches the 3D coordinates of the point. However, the quality of a point cloud that is reconstructed at the decoder side based on a voxelized representation may be dependent upon the level of depth of partitioning and, consequently, the maximum depth level of the octree structure. Thus, some amount of distortion will be introduced due to quantization, as the center of the cube in which a point is located may not be the same as the 3D coordinates of the point.

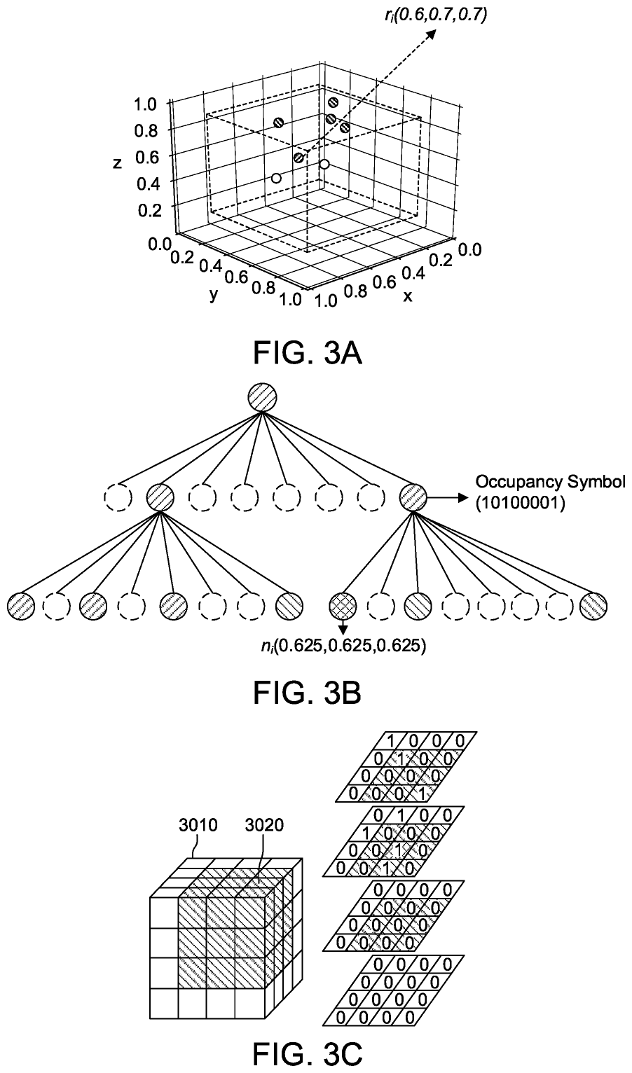

FIGS. 3A-3C are diagrams illustrating an example of a VoxelContextNet deep entropy model. FIG. 3A is a graphical representation of the raw input point cloud, with the location of a given point rᵢ expressed in 3D coordinates as (0.6, 0.7, 0.7). As shown in FIG. 3A, the region 3010 represents a neighborhood of the given point rᵢ.

FIG. 3B is a diagram illustrating the corresponding octree for the input point cloud. As shown in FIG. 3B, the given point rᵢ of the raw input point cloud has a corresponding leaf node nᵢ in the octree.

FIG. 3C is a diagram illustrating the detailed binary voxel representation of the 3D point cloud. Here, the space representing the 3D point cloud is partitioned along the x-axis, y-axis, and z-axis to produce a binary voxel representation of the space. The region 3010 is a local voxel representation of the neighborhood centered at the node nᵢ and summarizes the distribution of points at neighboring nodes at the same depth level. The context of the local voxel may be denoted as Vᵢ. As shown in FIG. 3C, the coordinates of the leaf node nᵢ are quantized to (0.625, 0.625, 0.625) based on the voxel representation of the space, thereby reflecting some amount of distortion in comparison when compared to the coordinates of the corresponding raw input point rᵢ.

Another approach for deep entropy modeling may involve self-supervised compression, which may use an adaptive entropy coder that operates on a tree-structured conditional entropy model. The information from the local neighborhood as well as the global topology may be utilized from the octree structure.

Another approach for deep entropy modeling, referred to herein as PointContextNet, may be described as follows. An octree represented point cloud may be coded in accordance with the present approach through a novel deep conditional entropy model. This deep entropy model may be implemented in both a point cloud encoder and a point cloud decoder. In particular, this deep entropy model may be utilized to extract a feature descriptor characterizing a local surface.

Such method may be understood to bridge the gap between existing tree-based conditional entropy models by resolving their drawbacks. First, a conditional entropy model such as OctSqueeze may have a high degree of dependency on ancestral features, which may make the model computationally intensive. This drawback may be overcome, for instance, by severing the dependency and explicitly considering the locations of nodes in the neighborhood of the current node to form a relevant context. This may stand in contrast to VoxelContextNet, where instead of generating a binary voxelized neighborhood to represent nodes in the neighborhood, the model may consider the 3D locations of nodes in the neighborhood. Secondly, the model proposed in VoxelContextNet may use 3D convolutions for feature extraction from the voxelized neighborhoods. A 3D convolution-based architecture may be advantageous for repeatable patterns in the 3D space but may fail to capture the intricate details within the scene. To this end, a deep entropy model referenced as PointContextNet using an MLP-based architecture may be more suitable for extracting such intricate details.

A basic PointContextNet architecture is described herein. A PointContextNet architecture may be deployed via a point-based neural network, which may utilize an MLP architecture. The architecture may include at least one set abstraction (SA) module, each module including one or more SA layers, which may operate successively to generate an MLP-based feature, f. Such a point-based network may have greater capabilities for representing intricate structures within a surface. PointContextNet may take a point set Vᵢ as an input, for instance, from a neighborhood of a current octree voxel point. It should be noted that Vᵢ may be provided in the form of 3D positions that are from a neighboring octree voxel to the current octree voxel at depth level dᵢ. The output feature f may then be concatenated with the known features, or context Cᵢ, of the current node, i.e., the current node's 3D location and its depth level dᵢ in the octree.

The architecture may further include at least one neural network module, which may be, for example, a fully connected (FC) module, each including one or more FC layers, and which may take the output feature f of the SA module as an input. The FC module may and produce a probability distribution.

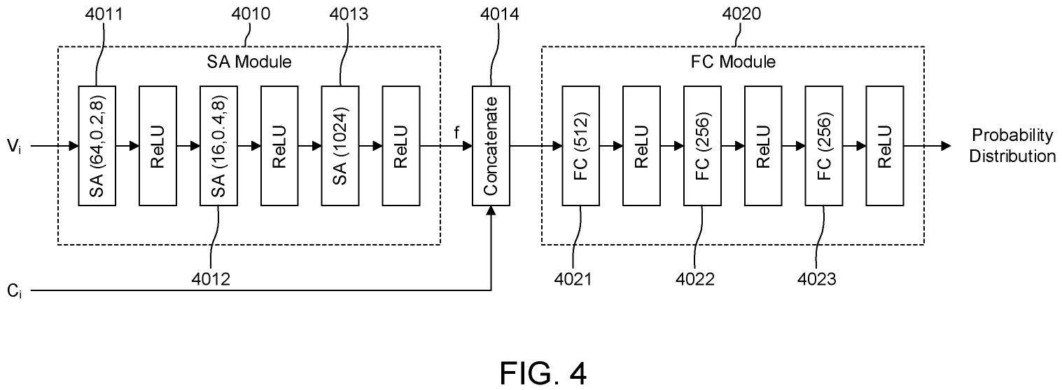

FIG. 4 is a diagram illustrating a point-based architecture according to one embodiment. The architecture includes at least an SA module 4010 and an FC module 4020. The SA module 4010 may include three (3) SA layers 4011, 4012, and 4013. Each SA layer 4011, 4012, and 4013 is respectively followed by a rectifier linear unit (ReLU) activation function.

In the case of SA layer 4011, for SA(64, 0.2, 8), the set of input points are abstracted as 64 points, each with a neighborhood radius of 0.2 and considering the eight nearest neighbors. In the second SA layer 4012, for SA(16, 0.4, 8), the abstracted points of SA layer 4011 are further abstracted as 16 points, each with a neighborhood radius of 0.4 and considering the eight nearest neighbors. As for SA layer 4012, for SA(1024), all output points from SA layer 4012 are abstracted as a single point with a feature vector of size 1024. At 4014, the output feature of the third SA layer is concatenated with the context of the current node.

At the FC module 4020, as illustrated for FC layer 4021, FC(512) indicates that a fully connected layer with output size 512 is implemented. The second FC layer 4022 has an output size of 256. As shown in the example of FIG. 4, the last FC layer 4023 also has an output of size 2⁸=256, corresponding to the allowed possibilities of the occupied children.

Further related to above-described PointContextNet architectures, some embodiments may provide enhancements considering input features from different resolutions or scales.

In some embodiments, the basic PointContextNet module may be enhanced multi-resolution grouping (MRG) techniques, which may entail concatenation of features from different abstraction levels. the SA module may include one or more parallel abstraction processes, each configured to take the input feature, Vᵢ, and perform abstraction at different levels of granularity. The abstracted feature of the first SA stage may undergo several further abstraction processes substantially as described above with respect to FIG. 4, and may be concatenated with output features produced by the parallel abstraction processes.

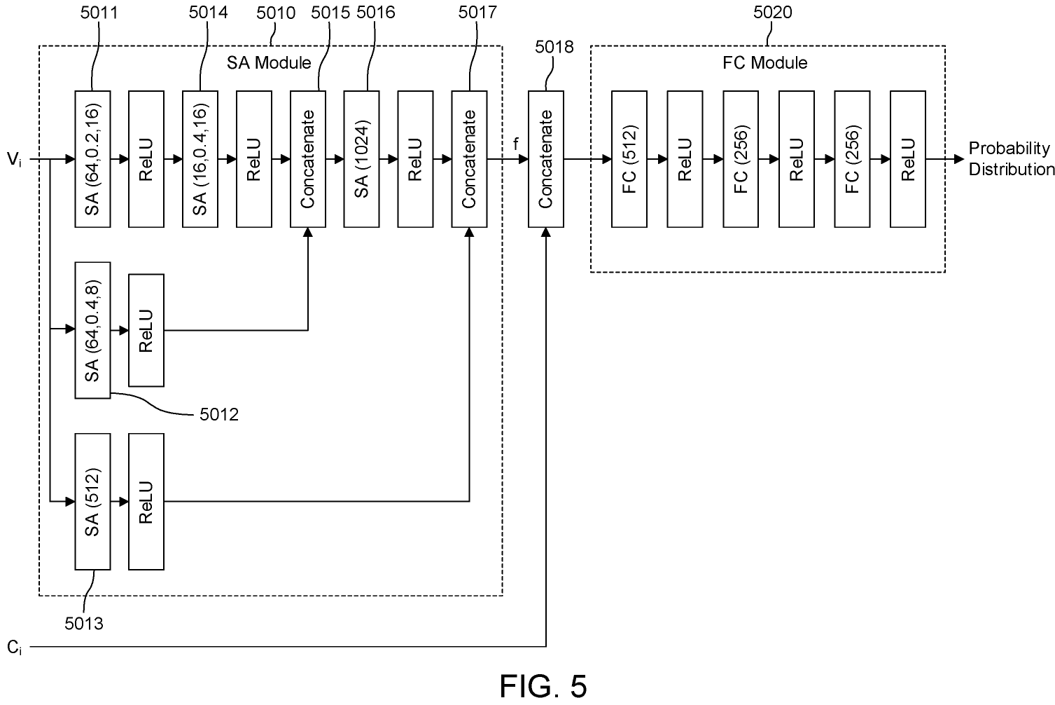

FIG. 5 illustrates an example of an enhanced PointContextNet architecture including an SA module 5010 and an FC module 5020. The SA layers 5011 may output an abstracted feature similar to the SA layer 4011 as described above, before passing the feature to subsequent SA layers 5014 and 5016. In parallel with the SA layer 5011, however, SA layers 5012 and 5013 are configured to produce abstracted features from the input feature Vᵢ using different parameters. For instance, the SA layers 5011, 5012, and 5013 can be configured to output features using different neighborhood radii, considering a different number of nearest neighbors, and/or having a different output feature size. The output feature of the SA layer 5012 may be concatenated with output feature of the SA layer 5014, and the output feature of the SA layer 5013 may be concatenated with the output feature of the SA layer 5016. Subsequently with the known features of the current node Cᵢ, ultimately to generate the final output feature f, which is passed to the FC module 5020.

In some embodiments, the PointContextNet may be enhanced using a multi-scale grouping (MSG) strategy. In multi-scale grouping, features may be extracted and combined from different scales at the same level of abstraction to form the output feature f.

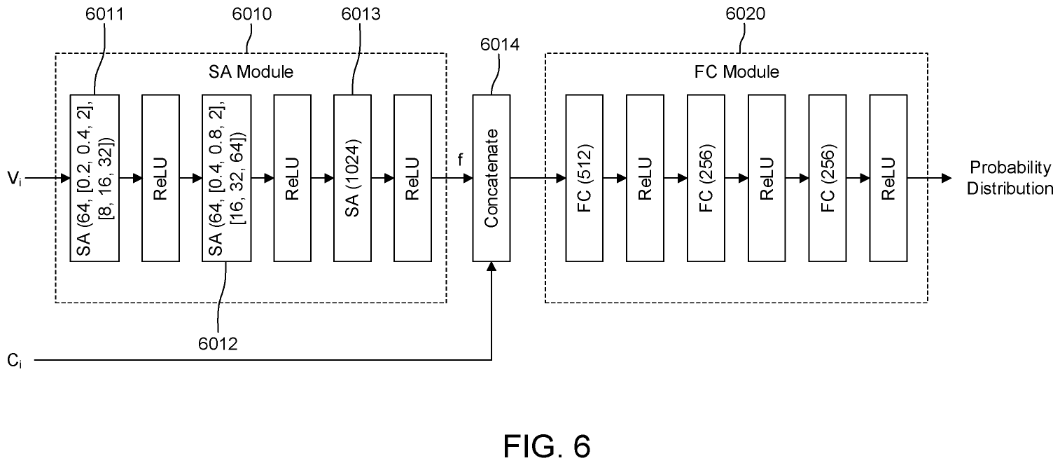

FIG. 6 illustrates yet another example of an enhanced PointContextNet architecture. As shown in FIG. 6, the SA module 6010 may include three (3) SA layers 6011, 6012, and 6013. For SA layer 6011, for SA(64, [0.2, 0.4, 2], [8, 16, 32]), the input points may be abstracted three times with 64 points in each instance, but in the first instance, considering a neighborhood radius of 0.2 using the eight nearest neighbors, in the second instance considering a neighborhood radius of 0.4 using the 16 nearest neighbors, and in the third instance considering a neighborhood radius of two using the 32 nearest neighbors. The SA layer 6012 may again perform abstraction in three instances for SA(64, [0.4, 0.8, 2], [16, 32, 64]), in a similar fashion. Similarly as described above with respect to FIG. 4, the third SA layer 6013 may take the output of SA layer 6012 and produce a further abstracted feature with 1024 points. The feature, f, is concatenated with the context, Cᵢ, of the current node before being passed to the FC module 6020.

A hybrid deep entropy model, referred to herein as PVContextNet (or PointVoxelContextNet), may be described as follows. The point based MLP employing architecture PointContextNet may extract intricate details very well in many scenes. However, it may be further improved by yet another deep entropy model with a hybrid architecture. At least one advantage of the hybrid architecture may come from the observation that a convolution branch may efficiently extract features explaining repeatable patterns whereas an MLP branch may more effectively extract the intricate details.

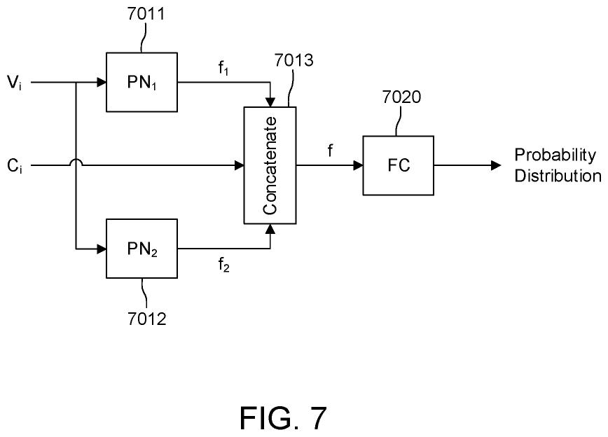

FIG. 7 illustrates an example of a hybrid deep entropy model consistent with one or more embodiments disclosed herein. A deep entropy model may take both the binary voxelized neighborhood point set around a current octree node (voxel) and their corresponding 3D locations of the points in the neighborhood as input. As shown in FIG. 7, with the hybrid architecture, the first branch 7011, which may be referred to as PN₁, may be implemented based on regular convolution, or one type of sparse convolution. The first branch may take the voxelized neighborhood as an input (similar to VoxelContextNet). When a regular convolution applies, the computation may be conducted over every voxel no matter if it is occupied or empty. When a sparse convolution applies, the computation may be conducted over only occupied voxels.

Computing may be inefficient when a convolutional kernel does not overlap with any occupied voxels. To address the waste of computational resource and memory consumption due to meaningless computation, a sparse convolution may be used to replace a regular convolution. Various types of sparse convolutions may be implemented consistent with one or more embodiments of the present disclosure. With a naïve sparse convolution, the computation may be conducted only when the convolution kernel is at least overlapped with some occupied voxel. With a submanifold sparse convolution, the computation is conducted only when the center of the convolution kernel is overlapped with an occupied voxel. The submanifold sparse convolution may require even less computation than a naïve sparse convolution, and may avoid a dilation issue that may occur in naïve sparse convolution when several convolution layers are concatenated. The convolution branch PN₁ may output a convolution-based feature f₁.

The hybrid architecture may maintain a second branch 7012 (referred to herein as PN₂), a point-based neural network, that is implemented similarly as described above with respect to the basic PointContextNet architecture. The point-based branch 7012 may take the 3D locations of the neighborhood points as inputs. The point branch 7012 may output an MLP-based feature f₂.

Once the two-branch feature extraction is done, as shown at 7013 their features f₁, and f₂ may be concatenated together as feature f. The feature f may then be further concatenated with the context information Cᵢ of the current octree node, i.e., its 3D location and the depth level dᵢ in the octree tree. Finally, the updated feature may be fed to a neural network module, e.g., an FC module that includes one or more fully connected layers in order to output an estimated probability distribution. The FC module 7020 as described for the hybrid model may use the same or a similar architecture as the FC module introduced and described substantially above with respect to FIG. 4. In some embodiments, the feature f could be a fused result, instead of a concatenation, from the feature f₁ and f₂ via a neural network module.

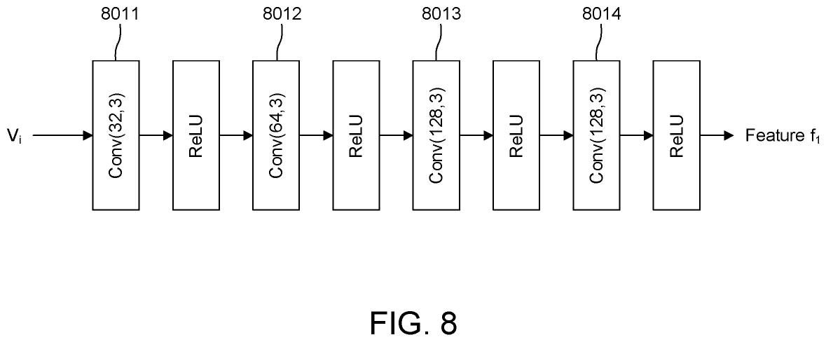

FIG. 8 illustrates an example design of the convolution-based branch. As shown in FIG. 8, a configured convolutional network may include four (4) convolution layers 8011, 8012, 8013, and 8014, with each followed by a ReLU activation layer. The expression Conv(32,3) may indicate that there are 32 channels with kernel size of three (3×3×3). FC(128) may refer to a fully connected layer with output size 128.

The convolution-based branch may take a point set Vᵢ as input, that is from a neighborhood of a current octree voxel point. It should be noted that Vᵢ may be provided in the form of an occupancy map that indicates whether a neighboring voxel is occupied or empty. An occupied voxel may be represented by a value ‘1’, and an empty voxel may be represented by a value ‘0’.

The design of a point-based branch according to some embodiments may be as follows. In some implementations, set abstraction architectures, such as the SA module illustrated in FIG. 4, may be used. In cases such as that illustrated in FIG. 4, this branch may include three (3) set abstraction layers, though it should be appreciated that a lesser or greater number of layers may be used. In some implementations, an MRG-enhanced SA module such as that shown in FIG. 5 may be implemented.

A complete octree-based point cloud codec consistent with one or more embodiments of the present disclosure may be described as follows. Namely, a complete description of an octree-based point cloud codec where the proposed deep entropy model may be applied is provided herein.

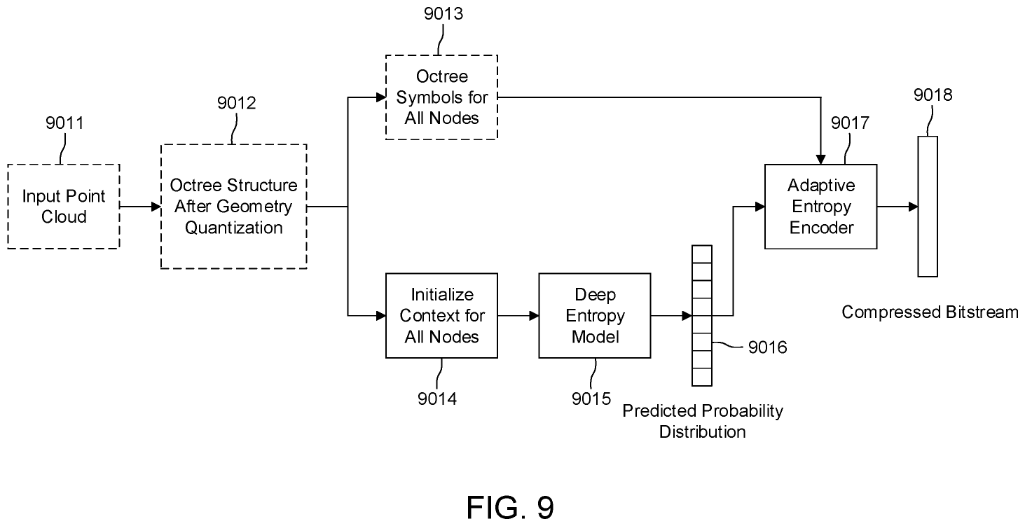

FIG. 9 is a flow diagram illustrating an example of point cloud encoding using a proposed deep entropy model consistent with one or more of the embodiments presented herein. For a point cloud encoding system, as shown at 9011, an input point cloud X with N points may be first processed and/or transformed. For example, the point cloud may be quantized up to a certain precision resulting in M points. These M points may then be further converted into a tree representation up to a certain specified tree depth, shown at 9012. Various tree representations or structures may be used. For example, the points can be converted into an octree representation, or a KD-tree representation, or a quadtree plus binary tree (QTBT) representation, or a prediction tree representation, etc. Occupancy symbols for all of the nodes of the tree structure may then be derived, as shown at 9013. Subsequently, as shown at 9017 an encoding device may perform point cloud encoding according to one or more of the embodiments proposed herein to produce a compressed bitstream 9018. For example, a hybrid architecture may be used to compute first and second features using a convolution-based neural network module and a point-based neural network module. In the example of FIG. 9, the architecture may be configured to initialize the context for all nodes, shown at 9014, and may implement a deep entry model 9015 to produce a predicted occupancy symbol distribution. The adaptive entropy encoder 9017 may produce the compressed bitstream 9018 upon the predicted probability distribution.

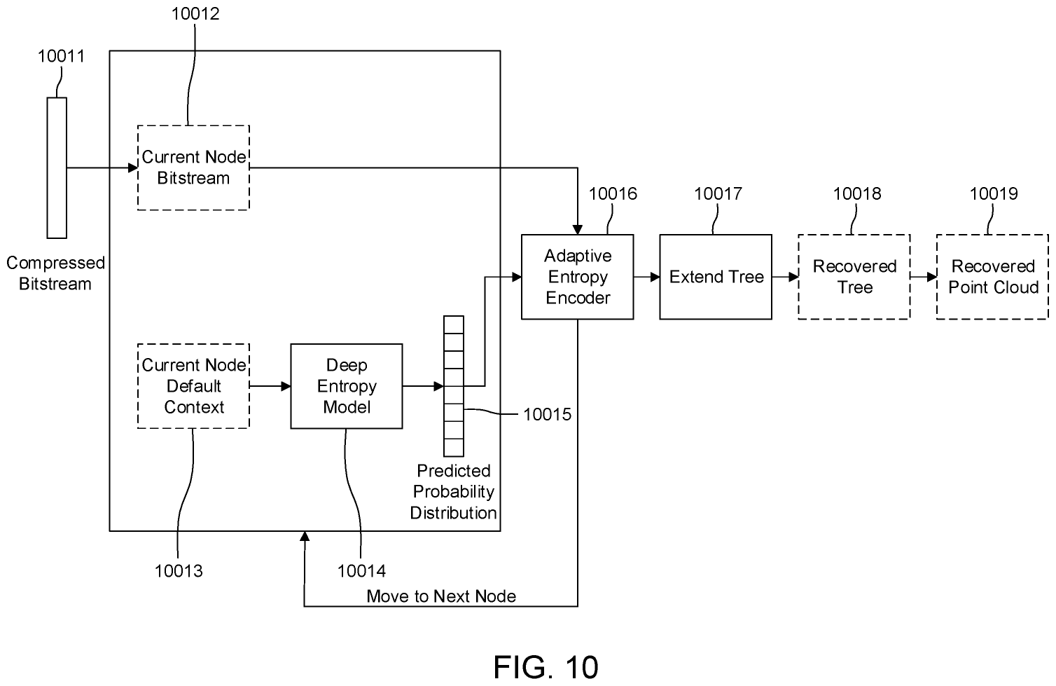

FIG. 10 is a flow diagram illustrating an example of a point cloud decoder using a proposed deep entropy model consistent with one or more of the embodiments presented herein. As shown in FIG. 10, at 10011, a decoding device may access point cloud data from an encoded bitstream. The bitstream may be compressed based on a tree structure. At 10012, Point data may be fetched, for example, in a neighborhood associated with a node of the tree structure. According to some embodiments, a voxelized version of the fetched points may be obtained for computation of features (e.g., via convolution-based methods). Decoding may be commenced at 10013 by first generating the default context for the root node of the tree. At 10014, the deep entropy model may then generate the occupancy symbol distribution 100015 using the default context of the root node. The adaptive entropy decoder may use this distribution, as shown at 10016, along with the part of the bitstream corresponding to the root node to decode the root occupancy symbol. The context of all children of the root node may now be initialized and the same procedure may be iterated several times to extend and decode the whole tree structure, as shown at 10017 and 10018. After the whole tree is decoded, it may be converted back to obtain the reconstructed point cloud 10019.

In general, at least one example of an embodiment may involve applying a deep entropy model to predict the occupancy symbol distribution. However, in addition to predicting the distribution with local information from the parent nodes, at least one example of an embodiment may involve utilizing more global information that is available. For example, when predicting the occupancy symbol distribution of a current node, information from one or more sibling nodes as well as from one or more ancestor nodes can be utilized.

An octree representation may be one straightforward way to divide and represent positions in the 3D space. In such representations, a cube containing the entire point cloud is subdivided into 8 sub-cubes. An 8-bit code, called an occupancy code or occupancy symbol, may then be generated by associating a 1-bit value with each sub-cube. The purpose of the 1-bit value may be to indicate whether a sub-cube contains points (i.e., with value 1) or not (i.e., with value 0). This division process may be performed recursively to form a tree, where only sub-cubes with more than one point are further divided. Similar to the octree representation, QTBT representations may also involve division of the 3D space recursively but may allow for more flexible division using quadtree or binary tree. Such QTBT representations may be particularly useful for representing sparse distributed point clouds. Different from octree and QTBT which divide the 3D space recursively, a prediction tree defines the prediction structure among the 3D points in a 3D point cloud. Geometry coding using prediction tree can, for example, be beneficial for contents such as LiDAR sequences in PCC. It should be noted that, with this conversion step, the compression of the raw point cloud geometry may become the compression of the tree representation.

For ease of explanation, the description refers primarily to octree representations. With the original point cloud converted into a tree structure, e.g., octree, at least one example of an embodiment may involve a deep entropy model to predict the occupancy symbol distributions for all nodes in the tree. A deep entropy model may operate in a nodewise fashion, and may provide a predicted occupancy symbol distribution of a node depending on its context and features from neighboring nodes in the tree, for example, using the proposed PointContextNet or the proposed hybrid PVContextNet. The tree structure may be traversed using, for example, a breadth-first traversal to have more uniformly distributed neighboring nodes.

The occupancy symbol of a node may refer to the binary occupancy of each of its 8 children nodes and may be represented as an 8-bit integer from the 8-bit binary children occupancies. The context of a given node may contain information such as, for example: occupancy of the parent node, e.g., as an 8-bit integer, the octree depth/level of the given node, the octant of the given node, and the spatial position of the current node. The conditional symbol distribution is then fed into a lossless adaptive entropy coder which compresses each node occupancy resulting in a bitstream.

It will be readily apparent to one skilled in the art that the examples of embodiments, features, principles, etc., described herein in the context of an octree representation may also be applicable to other types of tree representations. For example, for KD-tree representation, the neighborhood may include points in K-dimensions, rather than 3D points for octree, and the number of output probability states may be 2^{M}, where M=2^{K} as each node will have 2^{K} children. KD-tree may be used, for example, when additional features other than the point positions are present in the point cloud data. Since the neighboring points tend to have similar features, a reasonable neighborhood may be constructed which can be used for prediction, just like in the case of octree.

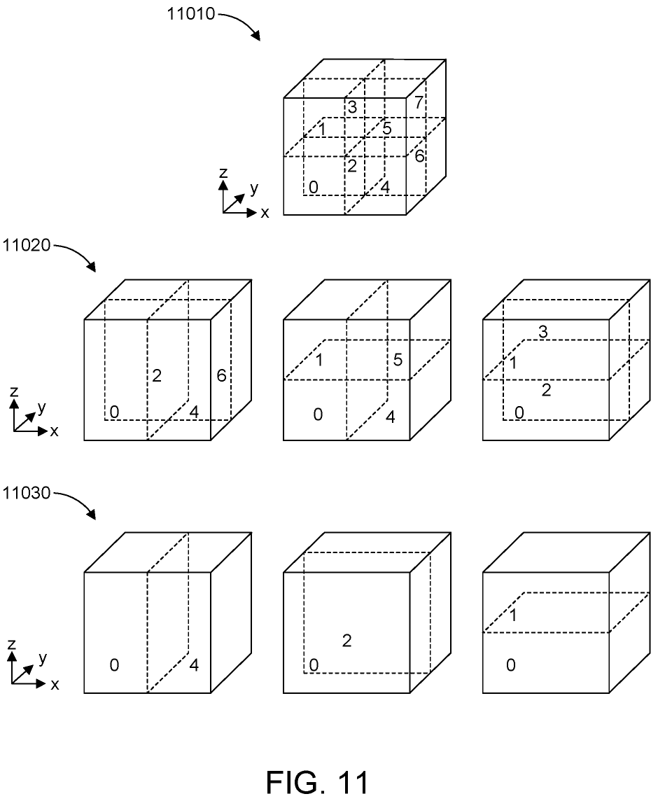

FIG. 11 illustrates various methods for 3D space partitioning and point cloud representation, including Octree, Quadtree, and Binary tree. QTBT, as introduced and described in paragraphs above, is one such example of a partitioning scheme that may be implemented in MPEG GPCC. QTBT may be built on top of an octree structure and may use implicit conditions to provide more flexibility in partitioning the 3D space by having asymmetric space partitioning. Unlike octree partitioning, shown at 11010, which may always partition a node (e.g., a 3D cube) into eight equal cubes by slicing along all three axes, QT may allow for slicing along only two axes, as shown at 11020, while BT may allow for slicing along only one axis, shown at 11030. The methods proposed in this text may be used for QTBT by keeping the general octree structure but freezing relevant output probabilities to zero probability depending on the implicit conditions that drive the partitioning decisions in QTBT.

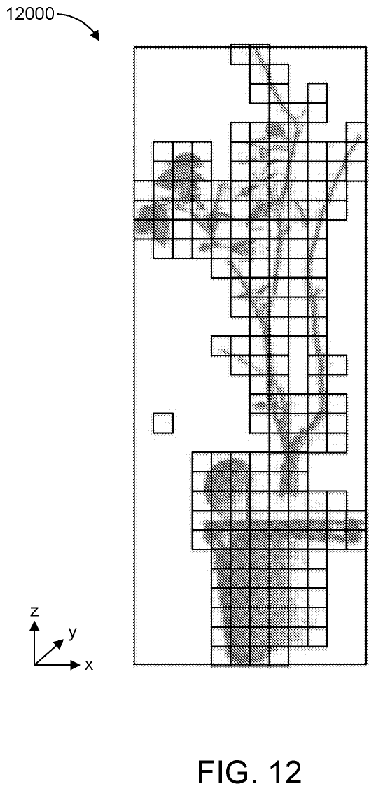

FIG. 12 is an example illustrating QTBT partitioning of a 3D point cloud. As can be seen in FIG. 12, the partitioning is shown at 12000 performed along only the x-z axes using QT principles, yet one can still have reasonable neighborhood information when using QTBT structure (just like an octree) which can be exploited for occupancy probability distribution prediction.

A variety of examples of embodiments, including tools, features, models, approaches, etc., are described herein. Many of these examples are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects.

In general, the examples of embodiments described and contemplated herein can be implemented in many different forms. FIG. 1 described above provides an example of an embodiment, but other embodiments are contemplated and the discussion of FIG. 1 does not limit the breadth of the possible embodiments or implementations.

At least one aspect of one or more examples of embodiments described herein generally relates to point cloud compression or encoding and decompression or decoding, and at least one other aspect generally relates to transmitting a bitstream generated or encoded. These and other aspects can be implemented in various embodiments such as a method, an apparatus, a computer readable storage medium having stored thereon instructions for encoding or decoding video data according to any of the methods described, and/or a computer readable storage medium having stored thereon a bitstream generated according to any of the methods described.

Various methods are described herein, and each of the methods comprises one or more steps or actions for achieving the described method. Unless a specific order of steps or actions is required for proper operation of the method, the order and/or use of specific steps and/or actions may be modified or combined.

Various numeric values are used in the present application such as the number of layers or depth of MLPs or the dimension of hidden features. The specific values are for example purposes and the aspects described are not limited to these specific values.

Various implementations involve decoding. “Decoding”, as used in this application, can encompass all or part of the processes performed, for example, on a received encoded sequence in order to produce a final output, e.g., suitable for display. In various embodiments, such processes include one or more of the processes typically performed by a decoder, for example, entropy decoding, inverse quantization, inverse transformation, etc. In various embodiments, such processes also, or alternatively, include processes performed by a decoder of various implementations described in this application.

As further examples, in one embodiment “decoding” refers only to entropy decoding, in another embodiment “decoding” can refer to a different form of decoding, and in another embodiment “decoding” can refer to a combination of entropy decoding and a different form of decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, transformation, quantization, entropy encoding, etc.

As further examples, in one embodiment “encoding” refers only to entropy encoding, in another embodiment “encoding” can refer a different form of encoding, and in another embodiment “encoding” can refer to a combination of entropy encoding and a different form of encoding. Whether the phrase “encoding process” is intended to refer specifically to a subset of operations or generally to the broader encoding process will be clear based on the context of the specific descriptions and is believed to be well understood by those skilled in the art.

When a figure is presented as a flow diagram, it should be understood that it also provides a block diagram of a corresponding apparatus. Similarly, when a figure is presented as a block diagram, it should be understood that it also provides a flow diagram of a corresponding method/process.

In general, the examples of embodiments, implementations, features, etc., described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. One or more examples of methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users. Also, use of the term “processor” herein is intended to broadly encompass various configurations of one processor or more than one processor.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. A method for decoding point cloud data organized in a tree structure, the method comprising:
accessing the point cloud data from an encoded bitstream by traversing the tree structure, wherein the tree structure comprises a root node and a plurality of child nodes;
fetching, from the accessed point cloud data, points in a spatial neighborhood associated with one of the plurality of child nodes;
computing a first feature, using a point-based neural network module, from three-dimensional (3D) point set associated with the fetched points;
computing a second feature, using a convolution-based neural network module, from voxelized point data representing the fetched points;
concatenating the first feature and the second feature with one or more known features of the one of the plurality of child nodes to compose a comprehensive feature;
predicting, using a neural network module, an occupancy symbol distribution for the one of the plurality of child nodes based on the comprehensive feature; and
determining, from the encoded bitstream, an occupancy for the one of the plurality of child nodes based on the predicted occupancy symbol distribution.

2. (canceled)

3. The method of claim 1, wherein the first feature computed using the convolution-based neural network module summarizes large smooth surfaces of a point cloud.

4. The method of claim 1, wherein the second feature computed using the point-based neural network module summarizes intricate details of a point cloud.

5. The method of claim 1, wherein the second feature is computed using the point-based neural network module by: generating, from the fetched points, a plurality of abstracted point sets, each of the plurality of abstracted point sets having different abstraction levels; and concatenating each of the plurality of abstracted point sets with each other.

6. The method of claim 1, wherein the second feature is computed using the point-based neural network module by: extracting a plurality of features from the fetched points using different scales and using a same abstraction level; and combining the extracted features.

7. The method of claim 1, further comprising predicting the occupancy symbol distribution for the one of the plurality of child nodes based on information associated with at least one another one of the plurality of child nodes related to the one of the plurality of child nodes or the root node.

8. The method of claim 1, wherein the tree structure is one of an octree, a quadtree, a quadtree plus binary tree (QTBT), or a kth dimensional (KD) tree.

9. The method of claim 1, wherein the one or more known features of the one of the plurality of child nodes least include a three-dimensional (3D) location of one of the plurality of child nodes and a depth level of the one of the plurality of child nodes in the tree structure.

10. A decoding device for decoding point cloud data organized in a tree structure, the decoding device comprising a processor configured to:
access the point cloud data from an encoded bitstream by traversing the tree structure, wherein the tree structure comprises a root node and a plurality of child nodes;
fetch, from the accessed point cloud data, points in a spatial neighborhood associated with one of the plurality of child nodes;
compute a first feature, using a point-based neural network module, based from three-dimensional (3D) locations of the fetched points;
compute a second feature, using a convolution-based neural network module, from voxelized point data representing the fetched points;
concatenate the first feature and the second feature with one or more known features of the one of the plurality of child nodes to compose a comprehensive feature;
predict, using a neural network module, an occupancy symbol distribution for the one of the plurality of child nodes based on the computed feature; and
determine, from the encoded bitstream, an occupancy for the one of the plurality of child nodes based on the predicted occupancy symbol distribution.

11. (canceled)

12. The decoding device of claim 10, wherein the first feature computed using the convolution-based neural network module summarizes large smooth surfaces of a point cloud.

13. The decoding device of claim 10, wherein the second feature computed using the point-based neural network module summarizes intricate details of a point cloud.

14. The decoding device of claim 10, wherein the second feature is computed using the point-based neural network module by: generating, from the fetched points, a plurality of abstracted point sets, each of the plurality of abstracted point sets having different abstraction levels; and concatenating each of the plurality of abstracted point sets with each other.

15. The decoding device of claim 10, wherein the second feature is computed using the point-based neural network module by: extracting a plurality of features from the fetched points using different scales and using a same abstraction level; and combining the extracted features.

16. The decoding device of claim 10, further comprising predicting the occupancy symbol distribution for the one of the plurality of child nodes based on information associated with at least one of another one of the plurality of child nodes related to the one of the plurality of child nodes or the root node.

17. The decoding device of claim 10, wherein the tree structure is one of an octree, a quadtree, a quadtree plus binary tree (QTBT), or a kth dimensional (KD) tree.

18. The decoding device of claim 10, wherein the one or more known features of the one of the plurality of child nodes at least include a three-dimensional (3D) location of the one of the plurality of child nodes and a depth level of the one of the plurality of child nodes in the tree structure.
